(19) United States
(12) Patent Application Publication
(10) Pub. No.: US 2025/0145296 A1
(43) Pub. Date: May 8, 2025

(54) FOLDABLE CHAIR AND AN AIRCRAFT INCLUDING THE SAME

(71) Applicants: HYUNDAI MOTOR COMPANY, Seoul (KR); KIA CORPORATION, Seoul (KR); HYUNDAI TRANSYS INC., Seosan-si (KR)

(72) Inventors: Suk Won Hong, Bucheon-si (KR); Ga Be Nam, Hwaseong-si (KR); Mu Young Kim, Osan-si (KR); Jong Seok Han, Suwon-si (KR); Gil Ju Kim, Hwaseong-si (KR); Sang Man Seo, Hwaseong-si (KR); Hyun Ji Lee, Suwon-si (KR); Hyung Rae Kim, Suwon-si (KR); Jeong Yong Yoo, Hwaseong-si (KR); Gyung Do Park, Hwaseong-si (KR); Dong Hwan Kim, Hwaseong-si (KR)

(73) Assignees: HYUNDAI MOTOR COMPANY, Seoul (KR); KIA CORPORATION, Seoul (KR); HYUNDAI TRANSYS INC., Seosan-si (KR)

(21) Appl. No.: 18/649,287

(22) Filed: Apr. 29, 2024

(30) Foreign Application Priority Data
Nov. 6, 2023 (KR) 10-2023-0151651

(51) Int. Cl. B64D 11/06

(52) U.S. Cl. CPC B64D 11/0639; B64D 11/0696

(57) ABSTRACT

A foldable chair includes a first frame; a second frame disposed in parallel with the first frame; a connection portion configured to movably connect the first frame and the second frame and change in length based on movement between the first frame and the second frame; a seat accommodation portion disposed on one of the first frame or the second frame; and a seat portion. In particular, at least a portion of the seat portion is accommodated in the seat accommodation portion, and the seat portion is configured to be drawn out from the seat accommodation portion and detachably fastened to the other of the first frame or the second frame.

### CROSS-REFERENCE TO RELATED APPLICATION(S)

This application claims the benefit of and priority to Korean Patent Application No. 10-2023-0151651, filed on Nov. 6, 2023, the disclosure of which is incorporated herein by reference in its entirety.

### BACKGROUND

### 1. Field

The present disclosure relates to a foldable chair and an aircraft including the same. More specifically, the present disclosure relates to a foldable chair that may be converted into a folding mode and a seating mode depending on a situation thereof, and an aircraft including the same.

### 2. Description of Related Art

Recently, interest in the advanced air mobility (AAM) field, including urban air mobility (UAM) and regional air mobility (RAM), has been growing. The main purpose of such air mobility vehicle (e.g., aircraft) is the transportation of passengers and goods.

In order to transport both passengers and goods using such air mobility vehicle, it is desired to easily secure a space for seating the passengers and a space for loading the goods.

A component occupying the largest portion of an internal space of an aircraft may be a passenger seat on which passengers sit on. In order to transport goods, a space for loading goods in existing aircraft involved dismantling and removing the passenger seats installed in the internal space to secure the loading space. However, since the operation of removing and reinstalling passenger seats is very cumbersome and inefficient, it may be realistically difficult to efficiently transport both passengers and goods using a single aircraft.

### SUMMARY

An aspect of the present disclosure is to provide a foldable chair that may be converted into a folding mode and a seating mode with a simple operation. As a result, the foldable chair increases usability and availability of an internal space, and an aircraft including the same.

According to another aspect of the present disclosure, a foldable chair includes a first frame; a second frame disposed in parallel with the first frame; and a connection portion configured to movably connect the first frame and the second frame and change in length based on movement between the first frame and the second frame. The foldable chair may also include a seat accommodation portion disposed on one of the first frame or the second frame; and a seat portion. In particular, at least a portion of the seat portion is accommodated in the seat accommodation portion and is provided to be drawable from the seat accommodation portion. The seat portion is configured to be drawn out from the seat accommodation portion and detachably fastened to the other of the first frame or the second frame. In other words, the seat accommodation portion is positioned on either the first frame or the second frame, while the seat portion is detachably fastened to the frame not occupied by the seat accommodation portion.

In an embodiment, the first frame may include a first leg frame and a first seat frame configured to be coupled to the first leg frame. The second frame may include a second leg frame disposed to face the first leg frame, and a second seat frame configured to be coupled to the second leg frame to face the first seat frame.

In an embodiment, the seat accommodation portion may be coupled to the first seat frame, and the second seat frame may be provided with a fastening hook configured to fasten the seat portion in a position facing the seat accommodation portion.

In an embodiment, the seat portion may include a seat screen. In particular, at least a portion of the seat screen is wound in the seat accommodation portion, and the seat screen is configured to be drawn out from or pulled into the seat accommodation portion. The seat portion may also include a holder configured to be coupled to the seat screen and fastened to the fastening hook.

In an embodiment, the holder may include: a connection member to which the seat screen is connected, and a fastening member configured to be rotatably connected to the connection member and fastened to the fastening hook. The fastening member may have a fastening hole corresponding to the fastening hook.

In an embodiment, the seat accommodation portion may include a housing in which the seat screen is accommodated, and a shaft configured to be rotatably disposed in the housing. At least a portion of the seat screen is wound around the shaft.

In an embodiment, the housing may be configured to be coupled to the second seat frame, and may form an opening in at least a portion of the housing to allow the seat screen to move.

In an embodiment, the seat screen may be drawn out from the housing when the shaft rotates in a first rotation direction, and may be pulled back into the housing when the shaft rotates in a second rotation direction opposite to the first rotation direction.

In an embodiment, the shaft may include an elastic structure configured to apply a restoring force to the seat screen in a direction to be pulled back into the seat accommodation portion, in a state in which at least a portion of the seat screen is drawn out from the seat accommodation portion.

In an embodiment, the elastic structure may provide a rotational restoring force to the shaft in the second rotation direction when the shaft rotates in the first rotation direction. The restoring force may act on the seat screen based on the rotational restoring force.

In an embodiment, the restoring force acting on the seat screen may have a magnitude to support a load of a seated person.

In an embodiment, the foldable chair is configured to be convertible into a folding mode or a seating mode. The folding mode may be a state in which the first frame and the second frame are in contact with each other and the seat portion is accommodated in the seat accommodation portion. The seating mode may be a state in which the first frame and the second frame are spaced apart from each other at a specified interval and the seat portion is drawn out and fastened to the second frame.

In an embodiment, the connection portion may be provided such that a length of the connection portion changes in a direction, parallel to a movement direction between the first frame and the second frame, in a state in which the first frame and the second frame are connected.

In an embodiment, both end portions of the connection portion may be configured to be connected to the first leg frame and the second leg frame, respectively. In particular, a length of the connection portion may decrease as the first leg frame and the second leg frame move closer to each other, and may increase as the first leg frame and the second leg frame move away from each other.

In an embodiment, the first leg frame and the second leg frame may be configured to be coupled to an installation surface on which the foldable chair is installed.

In an embodiment, at least one of the first leg frame or the second leg frame may be configured to be detachably coupled to the installation surface, and movable with respect to the installation surface.

According to an aspect of the present disclosure, an improved aircraft is provided. The aircraft includes a fuselage; and a foldable chair installed in the fuselage. The foldable chair includes: a first frame; a second frame disposed in parallel with the first frame; and a connection portion configured to movably connect the first frame and the second frame and change in length based on movement between the first frame and the second frame. The foldable chair may also include a seat accommodation portion disposed on one of the first frame or the second frame; and a seat portion. In particular, at least a portion of the seat portion is accommodated in the seat accommodation portion and is provided to be drawable from the seat accommodation portion. The seat portion is configured to be drawn out from the seat accommodation portion and detachably fastened to the other of the first frame or the second frame (i.e., the frame not occupied by the seat accommodation portion).

In an embodiment, the foldable chair is configured to be convertible into a folding mode or a seating mode. The folding mode may be a state in which the first frame and the second frame are in contact with each other and the seat portion is accommodated in the seat accommodation portion. The seating mode may be a state in which the first frame and the second frame are spaced apart from each other at a specified interval and the seat portion is drawn out and fastened to the second frame.

In an embodiment, the first frame and the second frame may be configured to be coupled to an installation surface of the fuselage. Additionally, at least one of the first frame or the second frame may be configured to be detachably coupled to the installation surface, and movable with respect to the installation surface.

In an embodiment, the foldable chair may be operated in the folding mode when goods are transported in the aircraft, and the foldable chair may be operated in the seating mode when passengers are transported in the aircraft.

### BRIEF DESCRIPTION OF DRAWINGS

The above and other aspects, features, and advantages of the present disclosure should be more clearly understood from the following detailed description, in taken conjunction with the accompanying drawings, in which:

FIG. 1 is a view illustrating a folding mode and a seating mode of a foldable chair according to an embodiment of the present disclosure;

FIG. 2 is a view illustrating an unfolded state between a folding mode and a seating mode of a foldable chair according to an embodiment of the present disclosure;

FIG. 3 is a view illustrating an unfolded state between a folding mode and a seating mode of a foldable chair according to an embodiment of the present disclosure;

FIG. 4 is a view illustrating an operation in which a seat portion of a foldable chair is drawn out and fastened according to an embodiment of the present disclosure;

FIG. 5 is a view illustrating an operation in which a seat portion of a foldable chair is drawn out and fastened according to an embodiment;

FIG. 6 is a view illustrating an operation in which a seat portion of a foldable chair is drawn out and fastened according to an embodiment;

FIG. 7 is a view illustrating an operation in which a seat portion of a foldable chair is drawn out from and pulled back into a seat accommodation portion according to an embodiment;

FIGS. 8A and 8B are views illustrating a connection portion of a foldable chair according to an embodiment of the present disclosure;

FIGS. 9A and 9B are views illustrating a modified example of a connection portion of a foldable chair according to an embodiment of the present disclosure;

FIG. 10 is a view illustrating a second frame and a coupling member of a foldable chair according to an embodiment of the present disclosure;

FIG. 11 is a view illustrating an operation in which a mode of a foldable chair is converted according to an embodiment of the present disclosure;

FIG. 12A is a view illustrating a state in which a foldable chair according to an embodiment of the present disclosure is installed on an aircraft and converted into a folding mode; and

FIG. 12B is a view illustrating a state in which a foldable chair according to an embodiment of the present disclosure is installed on an aircraft and converted into a seating mode.

The drawings described herein are for illustration purposes only and are not intended to limit the scope of the present disclosure in any way.

### DETAILED DESCRIPTION

Because the present disclosure may have various changes and may have various embodiments of the present disclosure, specific embodiments may be illustrated in the drawings and described in detail. However, the drawings and the detailed description of the embodiments are not intended to limit the present disclosure, and it should be understood to include all modifications, equivalents, and substitutes included in the spirit and scope of the present disclosure.

Terms such as first, second, and the like may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

The terms used in the present application may be only used to describe specific embodiments, and may not be intended to limit the present disclosure. The singular expression may include the plural expression unless the context clearly dictates otherwise. In the present application, terms such as “comprise,” “include,” “have,” or the like may be intended to designate that a feature, number, step, operation, component, part, or combination thereof described in the specification exists. However, the presence or addition of one or more other features, integers, steps, operations, constituent elements, components, and/or groups thereof is not excluded. When a component, device, element, or the like of the present disclosure is described as having a purpose or performing an operation, function, or the like, the component, device, or element should be considered herein as being “configured to” meet that purpose or to perform that operation or function.

Unless defined otherwise, all terms used herein, including technical or scientific terms, include the same meaning as commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal meaning unless explicitly defined in the present application.

When a component is referred to as being “connected” to or “in contact” with another component, it should be understood that it may be directly connected to or in contact with the other component, but other components may exist therebetween. On the other hand, when a component is referred to as being “directly connected” to or “directly in contact” with another component, it should be understood that there is no other component therebetween.

In this specification, an aircraft may mean a mobility vehicle that may move by flying in the sky. That is, in addition to referring to a helicopter, a drone, a tilt-rotor, a fixed-wing airplane, or the like, the aircraft may also include a vehicle that may move on the ground using wheels and the like and may fly with the wheels and the like, separated from the ground. Additionally, the aircraft may include a manned aircraft and an unmanned aircraft. The manned aircraft may include an aircraft that may operate autonomously, in addition to an aircraft controlled by a pilot (i.e., operator).

Hereinafter, embodiments of the present disclosure are described with reference to the drawings.

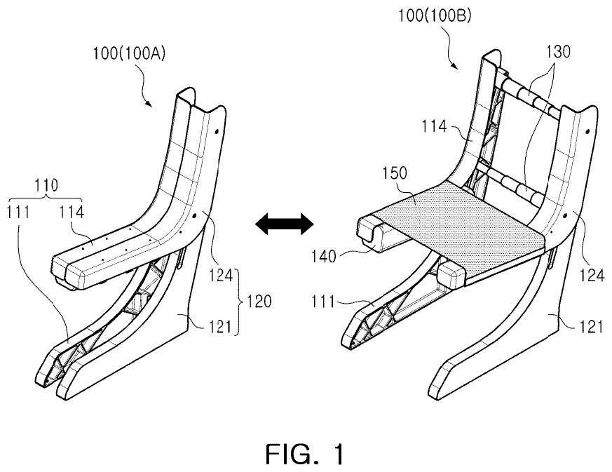

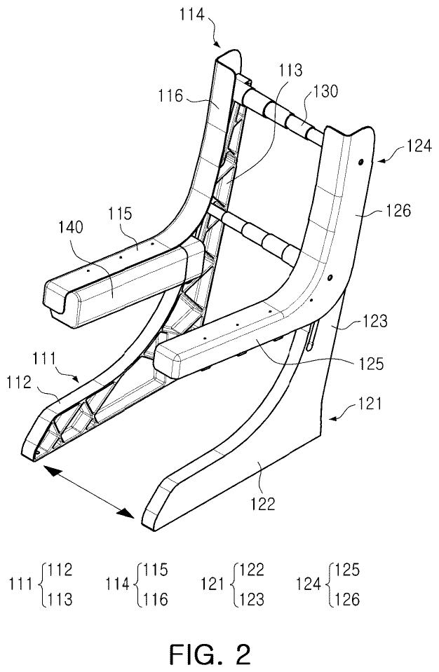

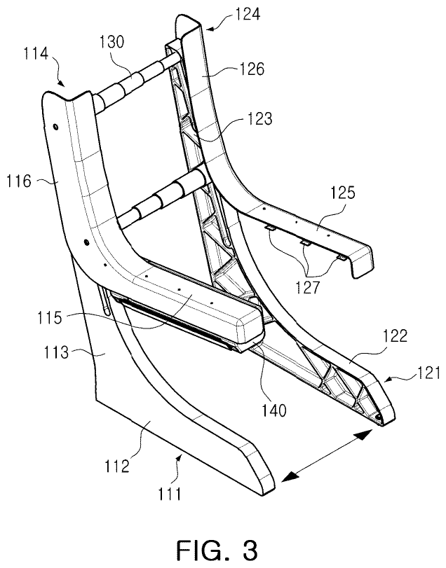

FIG. 1 is a view illustrating a folding mode and a seating mode of a foldable chair according to an embodiment of the present disclosure. FIG. 2 is a view illustrating an unfolded state between a folding mode and a seating mode of a foldable chair according to an embodiment of the present disclosure. FIG. 3 is a view illustrating an unfolded state between a folding mode and a seating mode of a foldable chair according to an embodiment of the present disclosure.

Referring to FIGS. 1-3, a foldable chair 100 according to an embodiment may be configured to be converted and/or modified into a folding mode 100A and a seating mode 100B. For example, the folding mode 100A may mean a state in which the foldable chair 100 is folded or collapsed, and is then accommodated. The seating mode 100B may mean a state in which the foldable chair 100 is unfolded or expanded such that seating is possible. The foldable chair 100 may be in an unfolded state (or expanded state) in a process of being converted into the folding mode 100A or the seating mode 100B. For example, the unfolded state may mean a state in which the foldable chair 100 is unfolded but a component for seating is not fastened.

A foldable chair 100 according to an embodiment may include a frame portion (110 and 120), a connection portion 130, a seat accommodation portion 140, and a seat portion 150.

The frame portion (110 and 120) may form a skeleton (or framework) of the foldable chair 100, and may include a first frame 110 and a second frame 120. The first frame 110 and the second frame 120 may be coupled to each other to form the frame portion (110 and 120). Other components included in the foldable chair 100 may be coupled to the first frame 110 and the second frame 120 and may support a load when a user sits on the foldable chair 100. The first frame 110 and the second frame 120 may be coupled to a floor surface in a moving means (e.g., a cabin of an aircraft, a fuselage, or an interior of a car) on which the foldable chair 100 is installed, through various coupling members.

The frame portion (110 and 120) may be configured such that the first frame 110 and the second frame 120 may move relative to each other. The first frame 110 and the second frame 120 may be arranged side by side. The first frame 110 and the second frame 120 may move away from or towards to each other by moving at least one of the first frame 110 or the second frame 120 while connected through the connection portion 130. Therefore, a state of the foldable chair 100 may be changed, as illustrated in FIG. 1.

For example, in a state in which the foldable chair 100 is installed in the moving means, the first frame 110 may be fixed, and a state of the foldable chair 100 may be changed, as the second frame 120 moves relative to the first frame 110. Conversely, the second frame 120 may be fixed, and a state of the foldable chair 100 may be changed, as the first frame 110 moves relative to the second frame 120. In this case, the connection portion 130 may support and assist a change in relative position between the first frame 110 and the second frame 120 while changing a length thereof in response to a distance between the first frame 110 and the second frame 120.

The first frame 110 and the second frame 120 may be configured to be symmetrical to each other, except for whether or not some components (e.g., a fastening hook 127) are provided. For example, the first frame 110 and the second frame 120 may be provided in a structure and/or a shape that may be symmetrical with respect to an imaginary plane, perpendicular to a movement direction thereof.

The first frame 110 may include a first leg frame 111 coupled to the moving means, and a first seat frame 114 coupled to the first leg frame 111.

The first leg frame 111 may include a first coupling portion 112 coupled to the moving means. Additionally, the first leg frame 111 may include a first support portion 113 extending from the first coupling portion 112 and supporting the first seat frame 114. For example, the first coupling portion 112 may be coupled to the moving means (e.g., a floor surface in an aircraft) through various fixing means. The first support portion 113 may extend from the first coupling portion 112 in an upward direction, and be coupled to the first seat frame 114. One end (e.g., a left end portion with respect to FIGS. 1-3) of the connection portion 130 may be coupled to the first support portion 113 of the first leg frame 111.

The first seat frame 114 may include a second coupling portion 116 coupled to the first leg frame 111, and a second support portion 115 extending from the second coupling portion 116 and supporting the seat portion 150. For example, the second coupling portion 116 may be coupled to the first support portion 113 of the first leg frame 111, and the second support portion 115 may extend from the second coupling portion 116 in parallel with the first coupling portion 112, to support the seat portion 150. In other words, the first seat frame 114, together with a second seat frame 124 of the second frame 120, may form a seating portion on which a user may sit.

The second frame 120 may include a second leg frame 121 coupled to the moving means, and a second seat frame 124 coupled to the second leg frame 121.

The second leg frame 121 may be disposed to face the first leg frame 111. The second leg frame 121 may include a third coupling portion 122 coupled to the moving means. The second leg frame 121 may include a third support portion 123 extending from the third coupling portion 122 and supporting the second seat frame 124. For example, the third coupling portion 122, like the first coupling portion 112, may be coupled to the moving means (e.g., a floor surface in an aircraft) through various fixing means, and the third support portion 123 may extend from the third coupling portion 122 in an upward direction, and be coupled to the second seat frame 124. The other end (e.g., a right end portion with reference to FIGS. 1-3) of the connection portion 130 may be coupled to the third support portion 123 of the second leg frame 121.

The second seat frame 124 may include a fourth coupling portion 126 coupled to the second leg frame 121, and a fourth support portion 125 extending from the fourth coupling portion 126 and supporting the seat portion 150. For example, the fourth coupling portion 126 may be coupled to the third support portion 123 of the second leg frame 121, and the fourth support portion 125 may extend from the fourth coupling portion 126 in parallel with the third coupling portion 122 to support the seat portion 150. In other words, the second seat frame 124, together with the first seat frame 114 of the first frame 110, may form a seating portion on which a user may sit.

The first frame 110 and the second frame 120 may be configured such that the seat accommodation portion 140 is disposed on one thereamong, and a fastening hook 127 fastening the seat portion 150 may be provided on the other one thereamong.

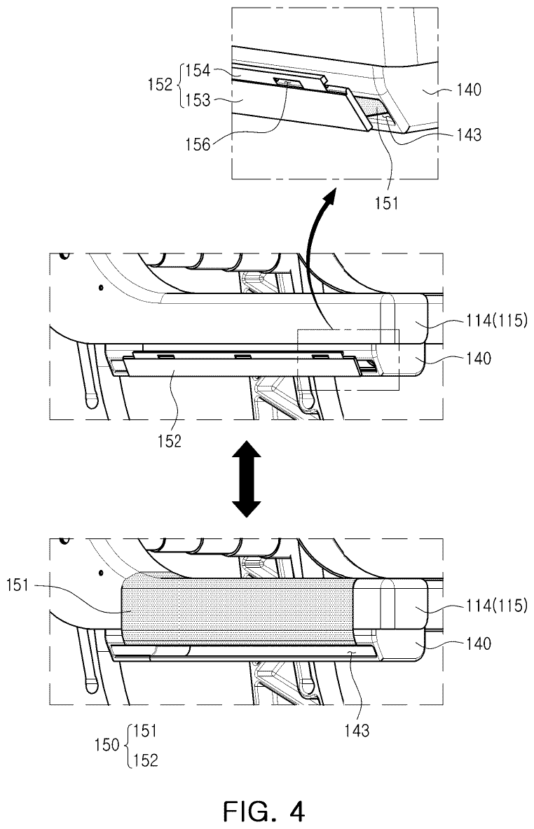

According to the embodiments illustrated in FIGS. 1-3, the first seat frame 114 of the first frame 110 may be provided with the seat accommodation portion 140. The second seat frame 124 of the second frame 120 may be provided with the fastening hook 127. For example, the seat accommodation portion 140 may be coupled to the second support portion 115 of the first seat frame 114, and the fastening hook 127 may be formed on the fourth support portion 125 of the second seat frame 124 facing the second support portion 115 such that the seat portion 150 drawn out from the seat accommodation portion 140 may be fastened to the fourth support portion 125. An operation of drawing the seat portion 150 out from the seat accommodation portion 140 and fastening the seat portion 150 to the fastening hook 127 is described in detail below with reference to FIGS. 4-7.

Positions of the seat accommodation portion 140 and the fastening hook 127 are described based on the embodiments illustrated in FIGS. 1-3. However, this is for convenience of explanation, and an embodiment of the present disclosure is not limited to the embodiments illustrated. According to various embodiments, the fastening hook 127 may be provided on the first seat frame 114, and the seat accommodation portion 140 may be provided on the second seat frame 124.

The connection portion 130 may connect the first frame 110 and the second frame 120. For example, the connection portion 130 may connect the first frame 110 and the second frame 120 such that the first frame 110 and the second frame 120 may move in a direction toward or away from each other. The connection portion 130 may be connected to the first leg frame 111 of the first frame 110 and the second leg frame 121 of the second frame 120. For example, both end portions of the connection portion 130 may be connected to the first support portion 113 of the first leg frame 111 and the third support portion 123 of the second leg frame 121, respectively. The connection portion 130 may be provided in plural. However, the present disclosure is not limited thereto, and the connection portion 130 may be provided in singular.

The connection portion 130 may change its length to be either longer or shorter in a direction, parallel to a movement direction of the first frame 110 or the second frame 120. The connection portion 130 may increase in length when converting from the folding mode 100A to the seating mode 100B, and the first frame 110 and the second frame 120 may move apart from each other to support an unfolding or expansion operation. In addition, the connection portion 130 may decrease in length when converting from the seating mode 100B to the folding mode 100A, and the first frame 110 and the second frame 120 may become closer to each other to support a folding or collapsing operation.

The connection portion 130 may limit a separation distance between the first frame 110 and the second frame 120. For example, the first frame 110 and the second frame 120 may be spaced apart from each other by a distance at which the connection portion 130 may be maximally extended. However, the present disclosure is not limited thereto, and a separate configuration may be provided to limit the separation distance between the first frame 110 and the second frame 120 regardless of a maximum length of the connection portion 130. For example, a floor surface on which the foldable chair 100 is installed may be provided with a protrusion or the like for contacting the first frame 110 and/or the second frame 120, such that the maximum separation distance between the first frame 110 and the second frame 120) may be also limited.

The seat accommodation portion 140 may accommodate at least a portion of the seat portion 150 therein, and may be provided to allow the seat portion 150 to be drawn out therefrom and pulled back thereinto. At least a portion of the seat portion 150 may be accommodated in the seat accommodation portion 140 in a wound state. The seat portion 150 may be drawn out from or pulled into the seat accommodation portion 140 while being unwound or wound by an external force. For example, when an external force is applied to the seat accommodation portion 140, the seat portion 150 may be drawn out (e.g., slide out) from the seat accommodation portion 140, and when an external force applied thereto is removed, the seat portion 150 may be pulled back into (e.g., slide in) the seat accommodation portion 140.

The seat accommodation portion 140 may be coupled to the first frame 110. The seat accommodation portion 140 may be coupled to the first seat frame 114 of the first frame 110. For example, the seat accommodation portion 140 may be coupled to the second support portion 115 of the first seat frame 114, but may be coupled to a lower surface of the second support portion 115 (e.g., a surface facing the first coupling portion 112) so as not to interfere with a passenger sitting. As previously described, the seat accommodation portion 140 may be coupled to the second frame 120.

The seat portion 150 may be a component for the user to sit on and may be provided to be drawn out from or pulled back into the seat accommodation portion 140, depending on a mode of the foldable chair 100. For example, the seat portion 150 may be accommodated in the seat accommodation portion 140 in the folding mode 100A, or may be drawn out from the seat accommodation portion 140 in the seating mode 100B. Additionally, the seat portion 150 may be fastened to the fastening hook 127, to provide a structure for sitting for a user.

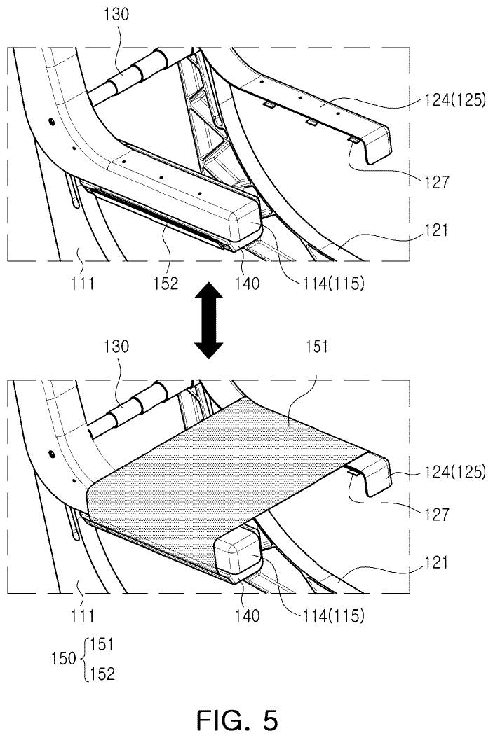

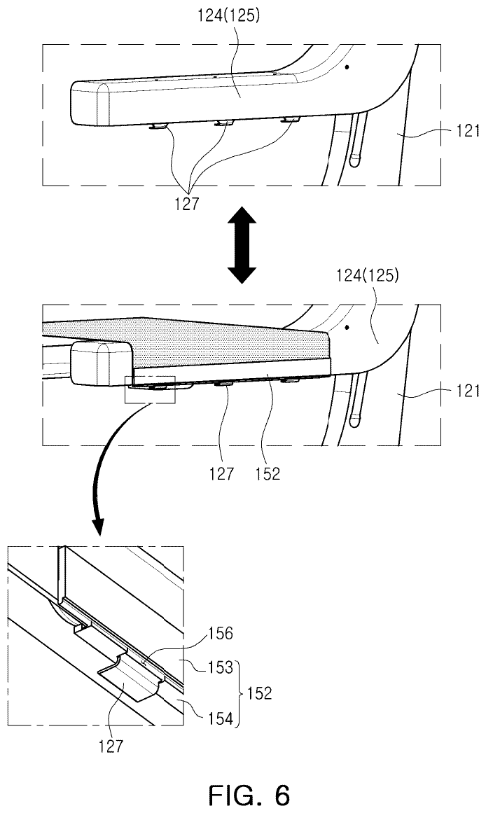

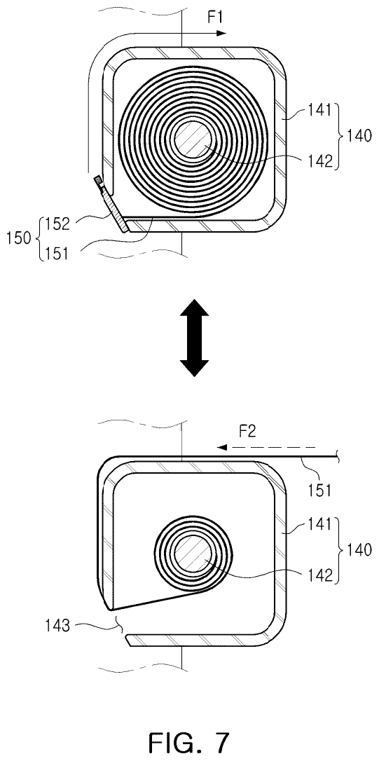

FIG. 4 is a view illustrating an operation in which a seat portion of a foldable chair is drawn out and fastened according to an embodiment of the present disclosure. FIG. 5 is a view illustrating an operation in which a seat portion of a foldable chair is drawn out and fastened according to an embodiment. FIG. 6 is a view illustrating an operation in which a seat portion of a foldable chair is drawn out and fastened according to an embodiment. FIG. 7 is a view illustrating an operation in which a seat portion of a foldable chair is drawn out from and pulled back into a seat accommodation portion according to an embodiment.

FIGS. 4-6 illustrate an operation of converting into a seating mode 100B, as illustrated in FIG. 1, as a seat portion 150 is drawn out and fastened to a second frame 120, when a foldable chair 100 is in an unfolded state, as illustrated in FIGS. 2 and 3. FIG. 7 illustrates an operation in which a seat portion 150 is drawn out and in by an external force F1 and a restoring force F2.

Referring to FIGS. 4-7, in a foldable chair 100 according to an embodiment, a first frame 110 and a second frame 120 may be unfolded, and a seat portion 150 may be drawn out from a seat accommodation portion 140 disposed on the first frame 110. Additionally, the seat portion 150 may be fastened to a second seat frame 124 of the second frame 120. As a result, the foldable chair 100 is converted into a seating mode 100B.

The seat portion 150 may include a seat screen 151 drawn out from the seat accommodation portion 140 to provide a portion for a user to sit on, and support the user's seating. Additionally, the seat portion 150 may include a holder 152 connected to one end of the seat screen 151.

The seat screen 151 may be provided such that one end thereof is connected to the holder 152 and the other end thereof is connected to a shaft 142 of the seat accommodation portion 140. The seat screen 151 may be pulled back into (e.g., pushed into) or drawn out from the seat accommodation portion 140, as the seat screen 151 is wound around the shaft 142 or unwound from the shaft 142.

The seat screen 151 may be drawn out from a housing 141 by being unwound from the shaft 142 by an external force F1 acting in a direction for drawing the seat screen 151 out from the housing 141 of the seat accommodation portion 140. In addition, when the applied external force F1 is removed or fastening of the seat screen 151 to the second seat frame 124 is released, the seat screen 151 may be pulled back into the housing 141 while being wound around the shaft 142 by a restoring force F2 acting in a direction for drawing the seat screen 151 back into the housing 141 of the seat accommodation portion 140. In this case, the external force F1 may be applied by the user (or seated person), and the restoring force F2 may be applied by a restoring structure (or elastic structure) provided on the shaft 142.

The seat screen 151 may be wound around the shaft 142, and may be formed of a material capable of supporting the load of the seated user. According to various embodiments, the seat screen 151 may be formed of a mesh material having a certain elasticity, but is not limited thereto. For example, the seat screen 151 may be constructed using various materials that may be accommodated in a wound state in the seat accommodation portion 140, and may provide a supporting force for supporting the load of a person sitting in the seating mode.

The holder 152 may be connected to one end of the seat screen 151, and may function as a portion that the user holds to draw the seat screen 151 out. The holder 152 may be exposed to an external space of the seat accommodation portion 140, regardless of a mode and a state of the foldable chair 100. For example, the user may hold the holder 152, and may apply the external force F1 for drawing the seat screen 151 out. In addition, when the holder 152 moves into an internal space of the seat accommodation portion 140 while winding the seat screen 151 around the shaft 142 by the restoring force F2 acting on the seat screen 151, the holder 152 may function as a stopper that limits movement to a specified range. For example, the holder 152 may restrict the seat screen 151 from being wound around the shaft 142, even when the restoring force F2 acts by contacting a peripheral portion of an opening 143 of the housing 141.

The holder 152 may include a connection member 153 connected to the seat screen 151, and a fastening member 154 connected to the connection member 153 and provided with a fastening hole 156.

The connection member 153 may connect the fastening member 154 and the seat screen 151. The connection member 153 may restrict the seat screen 151 from continuously being wound around the shaft 142 by contacting the housing 141 in relation to the stopper function of the holder 152. The connection member 153 may be provided in a plate shape having an area larger than an area of the opening 143 of the housing 141.

The fastening member 154 may be detachably fastened to a fastening hook 127 formed on the second frame 120. For example, the fastening hole 156 may be formed in the fastening member 154 into and to which the fastening hook 127 is inserted and coupled. In certain examples, there may be more than one fastening hole 156 and fastening hook 127. For example, multiple fastening holes 156 may be formed and a shape corresponding to those of the fastening hooks 127.

The fastening member 154 may be rotatably provided with respect to the connection member 153. For example, as illustrated in FIG. 4, before the seat screen 151 is pulled back into the seat accommodation portion 140, the fastening member 154 may be disposed parallel to the connection member 153. As illustrated in FIG. 6, to fasten to the fastening hook 127, the fastening member 154 may rotate from the connection member 153, and may be caught on the fastening hook 127 in a state disposed perpendicular to the connection member 153.

The seat portion 150 may be provided such that the restoring force F2 acts in a direction for drawing the seat screen 151 into the seat accommodation portion 140 (or along the shaft 142), due to a restoration structure (e.g., an elastic structure such as a spring or the like) provided on the shaft 142. When the seat screen 151 is drawn out and the holder 152 is fastened to the second seat frame 124, while acting a force on the seat screen 151 in a direction in which both end portions move away from each other due to the restoring force F2, the seat screen 151 may maintain a predetermined tension, thereby stably supporting the user's weight (e.g., load due to sitting). In addition, when the holder 152 is detached (e.g., dismantled) from the second seat frame 124, the seat screen 151 may be accommodated in the seat accommodation portion 140 while being wound around the shaft 142 without providing a separate external force due to the restoring force F2. In this case, the restoring force F2 may have a magnitude capable of withstanding the load of the seated person acting on the seat screen 151 in the seating mode 100B of the foldable chair 100.

The seat accommodation portion 140 may include a housing 141 in which at least a portion of the seat portion 150 is accommodated. The seat accommodation portion 140 may also include a shaft 142 rotatably disposed in the housing 141 and around which the seat screen 151 is wound.

The housing 141 may be provided with a space within which the shaft 142 and the seat screen 151 are accommodated. An opening 143 may be formed in the housing 141 through which the seat screen 151 is drawn out and into. The housing 141 may be coupled to the first seat frame 114 of the first frame 110. For example, the housing 141 may be coupled to the second support portion 115 of the first seat frame 114. The second support portion 115 may partially surround an exterior of the housing 141. The opening 143 formed in the housing 141 may not be overlap with the second support portion 115, such as not to be covered by the second support portion 115.

The shaft 142 may be rotatable in both directions in the housing 141. At least a portion of the seat screen 151 may be wound around the shaft 142, and the shaft 142 may rotate in response to a portion of the seat screen 151 being drawn out from and into the housing 141. For example, with reference to FIG. 7, when the seat screen 151 is drawn out, the shaft 142 may rotate in a first rotation direction (i.e. clockwise) and the seat screen 151 may be released from the shaft 142. Conversely, when the seat screen 151 is pulled back into, the shaft 142 may rotate in a second rotation direction (i.e., counterclockwise), opposite to the first rotation direction, and the seat screen 151 may be wound around the shaft 142.

The shaft 142 may have a restoration structure to provide the restoration force F2. For example, an elastic structure such as a spring or the like for providing a rotational restoring force may be provided on the shaft 142 in a direction for accommodating the seat screen 151 or a direction in which the seat screen 151 is wound around the shaft 142 (e.g., counterclockwise based on FIG. 7). Although not illustrated, the shaft 142 may be connected to the housing 141 by a spring structure that generates an elastic force or a restoring force. Additionally, in a basic state (or equilibrium state) when the shaft 142 rotates clockwise by the external force F1, the shaft 142 may be configured to generate a rotational restoring force in a counterclockwise direction to restore the shaft 142 to an original state thereof. As the rotational restoring force is generated in the shaft 142, the restoring force F2 may act on the seat screen 151 in a direction in which the seat screen 151 is accommodated in the housing 141. The restoration structure for providing the rotational restoring force to the shaft 142 may be implemented using various spring structures (or elastic structures) including a clockwork spring.

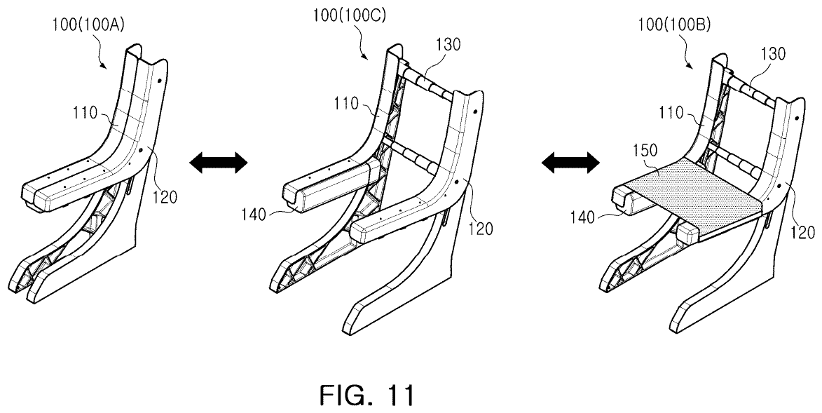

Referring to FIG. 7, an upper portion thereof illustrates a state in which the seat portion 150 is accommodated in the seat accommodation portion 140 in the folding mode 100A and the unfolded state (e.g., the state illustrated in FIGS. 2 and 3 and 100C in FIG. 11) of the foldable chair 100. Additionally, a lower portion thereof illustrates a state in which the seat portion 150 is drawn out as the external force F1 is applied in the accommodated state of the seat portion 150.

The shaft 142 may be configured to generate a rotational restoration force having a specified magnitude even when the external force F1 is not applied in the accommodating state of the seat accommodation portion 140 illustrated in the upper portion of FIG. 7. Through this, the seat screen 151 may maintain a certain amount of tension in a direction for winding around the shaft 142, such that the seat portion 150 may be stably maintained in the seat accommodation portion 140. However, this is illustrative, and the rotational restoring force may be generated in response to the application of the external force F1.

According to embodiments, various in the accommodating state of the seat accommodation portion 140 illustrated in the upper portion of FIG. 7, the rotational restoring force of the shaft 142 may not occur when the external force F1 is not applied, and may occur when the external force F1 is applied to rotate the shaft 142. For example, the rotational restoring force may occur, when the shaft 142 rotates in a direction in which the seat screen 151 is released by the external force F1 (e.g., clockwise with respect to FIG. 7), to act as a restoration force F2 on the seat screen 151.

Hereinafter, an operation of fastening/installing the seat portion 150 will be described with reference to FIGS. 4-7.

After converting a foldable chair 100 into an unfolded state 100C, a user may hold a holder 152 and apply an external force F1 in a direction for drawing a seat screen 151 out from a housing 141. The seat screen 151 extends to partially surround a second support portion 115 of a first frame 110 (e.g., a first seat frame 114) and a fourth support portion 125 of a second frame 120 (e.g., a second seat frame 124). A fastening member 154 of the holder 152 may be fastened to a fastening hook 127 provided in the fourth support portion 125. In a state in which the seat portion 150 is fastened, a restoring force F2 may act on the seat screen 151 in a direction in which the seat screen 151 is pulled back into the housing 141. The restoring force F2 has a magnitude capable of withstanding a load of a seated person. In a seating mode 100B of the foldable chair 100, the seat screen 151 may support the seated person by the restoring force F2.

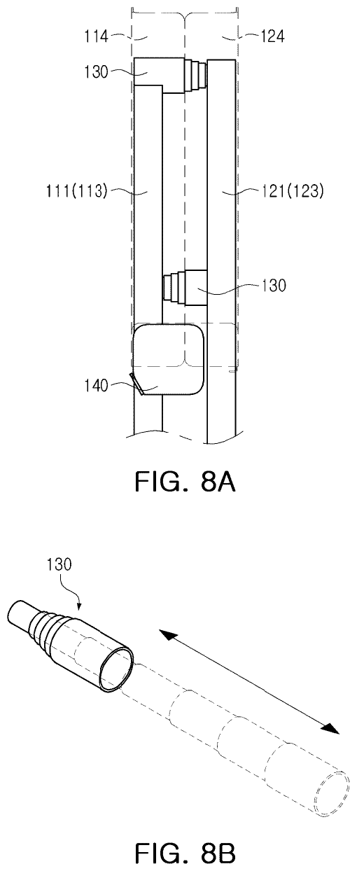

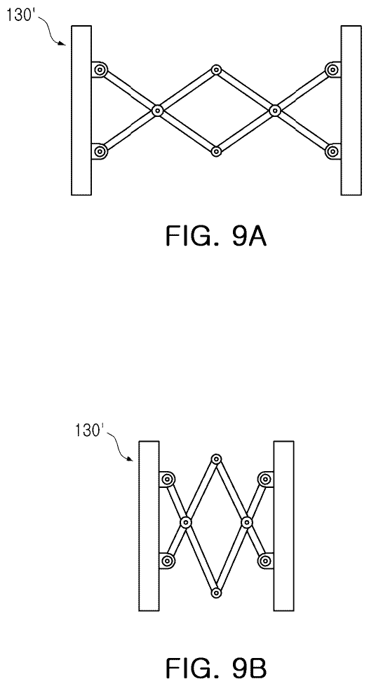

FIGS. 8A and 8B are views illustrating a connection portion of a foldable chair according to an embodiment of the present disclosure. FIGS. 9A and 9B are views illustrating a modified example of a connection portion of a foldable chair according to an embodiment of the present disclosure.

FIG. 8A illustrates a state in which a connection portion 130 is compressed, when a foldable chair 100 is in a folding mode (e.g., 100A in FIG. 1). FIG. 8B illustrates an operation in which a connection portion 130 is extended or shortened. FIGS. 9A and 9B illustrate a connection portion 130′ having a structure different from the connection portion 130 of FIGS. 8A and 8B.

Referring to FIGS. 8A and 8B, a connection portion 130 may be connected to a first frame 110 and a second frame 120, respectively. The connection portion 130 may be extended or shortened in a longitudinal direction such that a foldable chair 100 may be converted into a folding mode 100A or a seating mode (e.g., 100B in FIG. 1). A length of the connection portion 130 may be changed in response to the movement of the first frame 110 and the second frame 120 toward or away from each other, in a state in which both end portions of the connection portion 130 are connected to the first frame 110 and the second frame 120.

The connection portion 130 may have a structure in which a plurality of pipes having different sizes are connected. Each of the plurality of pipes included in the connection portion 130 may be accommodated in a different pipe connected to one side, and thus an overall length of the connection portion 130 may be shortened. Additionally, each of the plurality of pipes included in the connection portion 130 may protrude from distinct pipes connected on one side, thereby extending the overall length of the connection portion 130.

Referring to FIGS. 9A and 9B, a structure of a connection portion 130 is not limited to the embodiment illustrated in FIGS. 8A and 8B, and may be modified in various manners. As illustrated in FIGS. 9A and 9B, the connection portion 130′ may be provided in a structure in which frames on both sides are connected by a plurality of link members. The connection portion 130′ may be extended or shortened, as the plurality of link members rotatably move. For example, the connection portion 130′ may be provided in various structures in which both end portions thereof are connected to a first frame 110 and a second frame 120 and a change in length is possible in response to movement thereof. The connection portion 130′ may include a telescopic structure, a bellows structure, a folding structure, or a retractable structure.

According to various embodiments, the connection portion 130 may be configured to be connected to a separate driver (not illustrated), and a length thereof may be adjusted by the driver.

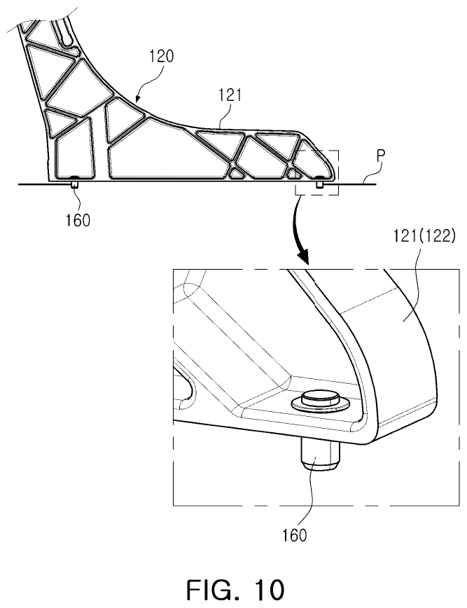

FIG. 10 is a view illustrating a second frame and a coupling member of a foldable chair according to an embodiment of the present disclosure.

Referring to FIG. 10, a second frame 120 may be restricted to an installation position P of a foldable chair 100 through a coupling member 160. The coupling member 160 may be detachably coupled to the second frame 120. For example, the second frame 120 may be restrained to the installation surface P through the coupling member 160, but when the coupling member 160 is separated from the second frame 120 and the installation surface P, movement may become possible.

Referring to FIGS. 1-3 described above, the foldable chair 100 may be folded or unfolded by movement of at least one of the first frame 110 or the second frame 120. For example, the foldable chair 100 may be configured such that the first frame 110 is firmly fixed to the installation surface P, and the second frame 120 is coupled through the coupling member 160. As a result, the coupling is released relatively easily.

According to this, when the foldable chair 100 is completely converted into the folding mode 100A and the seating mode 100B, the second frame 120 may be fixed to the installation surface P through the coupling member 160. When it is desired to convert the foldable chair 100, the coupling member 160 may be separated to release a restriction force of the second frame 120, and the second frame 120 may move with respect to the installation surface P and the first frame 110. However, the moving configuration is not necessarily limited to the second frame 120, and according to various embodiments, in a state in which the second frame 120 is fixed to the installation surface P, the first frame 110 may be configured to relatively move, or both the first frame 110 and the second frame 120 may be configured to move with respect to the installation surface P.

According to various embodiments, a guide rail for guiding movement of the first frame 110 and/or the second frame 120 may be formed on the installation surface P of a moving means on which the foldable chair 100 is installed.

FIG. 11 is a view illustrating an operation in which a mode of a foldable chair is converted according to an embodiment of the present disclosure.

Referring to FIG. 11, a foldable chair 100 according to an embodiment may be converted from a folding mode 100A to a seating mode 100B through an unfolded state 100C. Conversely, the foldable chair 100 may be converted from the seating mode 100B to the folding mode 100A through the unfolded state 100C.

First, an operation of converting from the folding mode 100A to the seating mode 100B is described. In describing FIG. 11, a first frame 110 may be fixed and a second frame 120 may move. However, as described above, a moving frame may be modified in various manners.

When the foldable chair 100 is in the folding mode 100A, the second frame 120 may move by a specified distance in a direction away from the first frame 110, and the foldable chair 100 may be converted into the unfolded state 100C. In this case, a length of a connection portion 130 may increase, as the second frame 120 moves. When the foldable chair 100 is in the unfolded state 100C, a seat portion 150 may be drawn out from a seat accommodation portion 140 disposed on the first frame 110. The seat portion 150 may be fastened to the second frame 120 to be converted into the seating mode 100B.

In an operation of converting the foldable chair 100 from the folding mode 100A to the seating mode 100B, an operation of moving the second frame 120 and an operation of drawing the seat portion 150 out and fastening to the second frame 120 may be performed based on an external force applied by a user.

Next, an operation of converting from the seating mode 100B to the folding mode 100A is described. The operation of converting from the seating mode 100B to the folding mode 100A may be opposite to the operation of converting from the folding mode 100A to the seating mode 100B.

When the foldable chair 100 is in the seating mode 100B, the seat portion 150 may be separated (unfastened) from the second frame 120. The seat portion 150 may be pulled back into the seat accommodation portion 140 to be converted into the unfolded state 100C. When the foldable chair 100 is in the unfolded state 100C, the second frame 120 may move in a direction closer to the first frame 110, and may be in contact with the first frame 110. The foldable chair 100 may be converted into the folding mode 100A. In this case, the length of the connection portion 130 may decrease, as the second frame 120 moves.

In an operation of converting the foldable chair 100 from the seating mode 100B to the folding mode 100A, an operation of moving the second frame 120 and an operation of unfastening the seat portion 150 may be performed based on an external force applied by the user. Additionally, an operation of drawing the seat portion 150 out into the seat accommodation portion 140 may be performed by a restoring force (e.g., restoring force F2 in FIG. 7) applied to the seat portion 150.

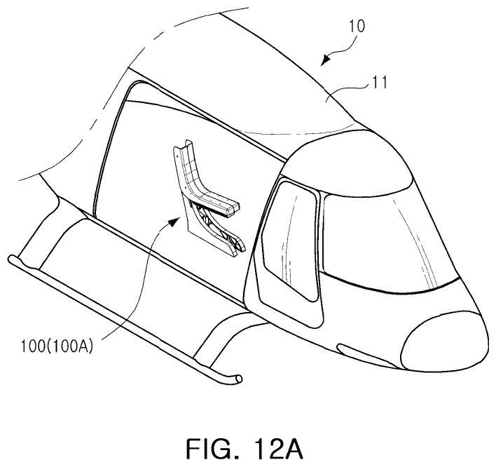

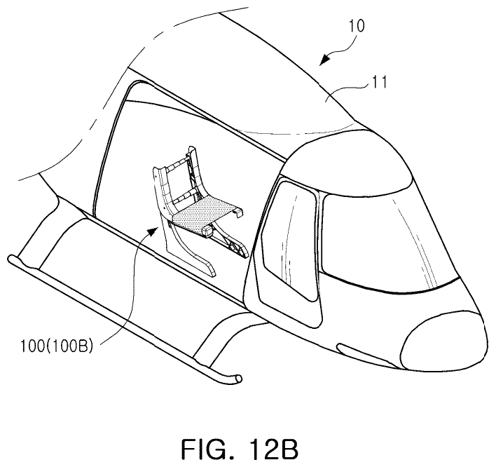

FIG. 12A is a view illustrating a state in which a foldable chair according to an embodiment of the present disclosure is installed on an aircraft and converted into a folding mode. FIG. 12B is a view illustrating a state in which a foldable chair according to an embodiment of the present disclosure is installed on an aircraft and converted into a seating mode.

Referring to FIGS. 12A and 12B, a foldable chair 100 according to an embodiment, as described with reference to FIGS. 1-11, may be installed on an aircraft 10. For example, the foldable chair 100 may be installed in a cabin (e.g., fuselage 11) in the aircraft 10 such that a passenger on board the aircraft 10 may sit. FIGS. 12A and 12B illustrate an embodiment to which the foldable chair 100 is applied, and a moving means on which the foldable chair 100 is installed is not limited to the aircraft 10. The aircraft 10 may include, but is not limited to, advanced air mobility (AAM), urban air mobility (UAM), and regional air mobility (RAM).

The aircraft 10 to which a foldable chair 100 according to an embodiment is applied may convert the mode of the foldable chair 100 according to a case of transporting passengers or a case of transporting goods.

For example, when transporting the goods by the aircraft 10, as illustrated in FIG. 12A, the foldable chair 100 may be converted into a folding mode 100A to secure a space for the goods to be loaded. In addition, when transporting the passengers by the aircraft 10, as illustrated in FIG. 12B, the foldable chair 100 may be converted into a seating mode 100B to provide seats for the passengers.

According to this, it becomes very easy to secure a loading space for goods in the aircraft 10 by mode conversion of the foldable chair 100. As a result, it is possible to effectively achieve both the purpose of transporting the passengers and the purpose of transporting the goods with a single aircraft 10.

According to an embodiment of the present disclosure, a foldable chair may be converted into a folding mode and a seating mode with a simple operation. As a result, a loading space for transporting goods may be easily secured without dismantling/removing the chair, and usability of an internal space of an aircraft may increase.

While the embodiments have been illustrated and described above, it should be apparent to those having ordinary skill in the art that modifications and variations could be made without departing from the scope of the present disclosure as defined by the appended claims.

Additionally, in embodiments of the present disclosure, some components may be deleted, and the components of each embodiment may be combined with each other.

What is claimed is:

1. A foldable chair comprising:
a first frame;
a second frame disposed in parallel with the first frame;
a connection portion configured to movably connect the first frame and the second frame and change in length based on movement between the first frame and the second frame;
a seat accommodation portion disposed on one of the first frame or the second frame; and
a seat portion, wherein at least a portion of the seat portion is accommodated in the seat accommodation portion,
wherein the seat portion is configured to be drawn out from the seat accommodation portion and detachably fastened to the other of the first frame or the second frame.

2. The foldable chair of claim 1, wherein the first frame comprises a first leg frame and a first seat frame configured to be coupled to the first leg frame, and
wherein the second frame comprises a second leg frame disposed to face the first leg frame, and a second seat frame configured to be coupled to the second leg frame to face the first seat frame.

3. The foldable chair of claim 2, wherein the seat accommodation portion is coupled to the first seat frame, and
wherein the second seat frame is provided with a fastening hook configured to fasten the seat portion in a position facing the seat accommodation portion.

4. The foldable chair of claim 3, wherein the seat portion comprises:
a seat screen configured to be drawn out from or pulled back into the seat accommodation portion, and
a holder configured to be coupled to the seat screen and fastened to the fastening hook.

5. The foldable chair of claim 4, wherein the holder comprises:
a connection member to which the seat screen is connected, and
a fastening member configured to be rotatably connected to the connection member and fastened to the fastening hook,
wherein the fastening member has a fastening hole corresponding to the fastening hook.

6. The foldable chair of claim 4, wherein the seat accommodation portion comprises:
a housing in which the seat screen is accommodated, and
a shaft configured to be rotatably disposed in the housing and around which at least a portion of the seat screen is wound.

7. The foldable chair of claim 6, wherein the housing is configured to be coupled to the second seat frame, and configured to form an opening in at least a portion of the housing to allow the seat screen to move.

8. The foldable chair of claim 6, wherein the seat screen is drawn out from the housing when the shaft rotates in a first rotation direction, and the seat screen is pulled into the housing when the shaft rotates in a second rotation direction opposite to the first rotation direction.

9. The foldable chair of claim 8, wherein the shaft comprises an elastic structure configured to apply a restoring force to the seat screen in a direction to be pulled into the seat accommodation portion, in a state in which at least a portion of the seat screen is drawn out from the seat accommodation portion.

10. The foldable chair of claim 9, wherein the elastic structure provides a rotational restoring force to the shaft in the second rotation direction when the shaft rotates in the first rotation direction, and
wherein the restoring force acts on the seat screen based on the rotational restoring force.

11. The foldable chair of claim 9, wherein the restoring force acting on the seat screen has a magnitude to support a load of a seated person.

12. The foldable chair of claim 9, wherein the foldable chair is configured to be convertible into a folding mode or a seating mode,
wherein the folding mode is a state in which the first frame and the second frame are in contact with each other and the seat portion is accommodated in the seat accommodation portion, and
wherein the seating mode is a state in which the first frame and the second frame are spaced apart from each other at a specified interval and the seat portion is drawn out and fastened to the second frame.

13. The foldable chair of claim 2, wherein the connection portion is provided such that a length of the connection portion changes in a direction, parallel to a movement direction between the first frame and the second frame, in a state in which the first frame and the second frame are connected.

14. The foldable chair of claim 13, wherein both end portions of the connection portion are configured to be connected to the first leg frame and the second leg frame, respectively, and
wherein a length of the connection portion decreases as the first leg frame and the second leg frame move closer to each other, and increases as the first leg frame and the second leg frame move away from each other.

15. The foldable chair of claim 2, wherein the first leg frame and the second leg frame are configured to be coupled to an installation surface on which the foldable chair is installed.

16. The foldable chair of claim 15, wherein at least one of the first leg frame or the second leg frame is configured to be detachably coupled to the installation surface, and movable with respect to the installation surface.

17. An aircraft comprising:
a fuselage; and
a foldable chair installed in the fuselage,
wherein the foldable chair includes:
a first frame;
a second frame disposed in parallel with the first frame;
a connection portion configured to movably connect the first frame and the second frame and change in length based on movement between the first frame and the second frame;
a seat accommodation portion disposed on one of the first frame or the second frame; and
a seat portion, wherein at least a portion of the seat portion is accommodated in the seat accommodation portion, and
wherein the seat portion is configured to be drawn out from the seat accommodation portion and detachably fastened to the other of the first frame or the second frame.

18. The aircraft of claim 17, wherein the foldable chair is configured to be convertible into a folding mode or a seating mode,
wherein the folding mode is a state in which the first frame and the second frame are in contact with each other and the seat portion is accommodated in the seat accommodation portion, and
wherein the seating mode is a state in which the first frame and the second frame are spaced apart from each other at a specified interval and the seat portion is drawn out and fastened to the second frame.

19. The aircraft of claim 18, wherein the first frame and the second frame are configured to be coupled to an installation surface of the fuselage, and
wherein at least one of the first frame or the second frame is configured to be detachably coupled to the installation surface, and movable with respect to the installation surface.

20. The aircraft of claim 18, wherein the foldable chair is operated in the folding mode when goods are being transported in the aircraft, and
wherein the foldable chair is operated in the seating mode when passengers are being transported in aircraft.
